(19) United States
(12) Patent Application Publication
(10) Pub. No.: US 2017/0116505 A1
(43) Pub. Date: Apr. 27, 2017

(54) AUTHENTICATION TOKEN

(71) Applicant: NXP B.V., Eindhoven (NL)

(72) Inventor: Thomas Suwald, Hamburg (DE)

(21) Appl. No.: 15/331,859

(22) Filed: Oct. 22, 2016

(30) Foreign Application Priority Data
Oct. 23, 2015 (EP) 15191281.3

(51) Int. Cl. G06K 19/07; G06K 9/00

(52) U.S. Cl. CPC G06K 19/07; G06K 9/00013; G06K 9/00087; H04L 63/0861

(57) ABSTRACT

According to a first aspect of the present disclosure, an authentication token is provided that comprises an authentication module and at least one conductive wire for operatively connecting the authentication module to at least one further module of the token, said at least one conductive wire being embedded in a non-conductive substrate of said token. According to a second aspect of the present disclosure, a corresponding method of manufacturing an authentication token is conceived.

### FIELD

The present disclosure relates to an authentication token. Furthermore, the present disclosure relates to a corresponding method of manufacturing an authentication token.

### BACKGROUND

Today, authentication tokens such as smart cards are widely used in society. For example, smart cards may be used as electronic identity (eID) cards or bank cards, and may serve, among others, to authenticate the holder of said smart card to governmental or commercial institutions. That is to say, authentication tokens of this kind may be used for verifying the identity of a user in order to enable, for example, a payment transaction. Verifying the identity of a user is often done by requesting the user to input a personal identification number (PIN), which may subsequently be verified by a secure processing unit comprised in the token. There may be a need for an authentication token which is easy to produce. Furthermore, there may be a need for an authentication token which is secure, yet easy to use.

### SUMMARY

According to a first aspect of the present disclosure, an authentication token is provided that comprises an authentication module and at least one conductive wire for operatively connecting the authentication module to at least one further module of the token, said at least one conductive wire being embedded in a non-conductive substrate of said token.

In one or more embodiments, the authentication module comprises a fingerprint sensor and a processing unit which are operatively connected to each other.

In one or more embodiments, the authentication module further comprises a secure element which is operatively connected to the processing unit.

In one or more embodiments, the token further comprises an interface module, wherein the authentication module is operatively connected to the interface module through the at least one conductive wire.

In one or more embodiments, the interface module is a contact-based interface unit, in particular an interface unit conforming to the technical standard ISO/IEC 7816.

In one or more embodiments, the non-conductive substrate is a thermoplastic substrate.

In one or more embodiments, the thermoplastic substrate is an inlay substrate.

In one or more embodiments, the authentication module is integrally formed as a single component.

In one or more embodiments, the conductive wire has at least one ending that has a meander form or a spiral form and that serves as a contact pad for connecting the authentication module or the further module to said conductive wire.

In one or more embodiments, said ending has been prepared for connection to the authentication module or the further module by carrying out a milling process.

In one or more embodiments, the token further comprises an antenna embedded in the non-conductive substrate.

In one or more embodiments, the conductive wire is made of the same material as said antenna.

In one or more embodiments, the conductive wire is an insulated conductive wire.

In one or more embodiments, the token is a smart card.

According to a second aspect of the present disclosure, a method of manufacturing an authentication token is conceived, the method comprising providing the token with an authentication module and with at least one conductive wire for operatively connecting the authentication module to at least one further module of the token, wherein said at least one conductive wire is embedded in a non-conductive substrate of said token.

### DESCRIPTION OF DRAWINGS

Embodiments will be described in more detail with reference to the appended drawings, in which:

FIG. 1 shows an illustrative embodiment of an authentication token;

FIG. 2 shows an illustrative embodiment of a dual-interface smart card;

FIG. 3 shows an illustrative embodiment of an authentication module;

FIG. 4 shows an illustrative embodiment of an interface module;

FIG. 5 shows an illustrative embodiment of a wire-embedding process;

FIG. 6 shows an illustrative embodiment of wire endings;

FIG. 7 shows an illustrative embodiment of a module interconnection layer;

FIG. 8 shows an illustrative embodiment of a card layer stack;

FIG. 9 shows an illustrative embodiment of a cavity creation process;

FIG. 10 shows an illustrative embodiment of an insulation removal process;

FIG. 11 shows a top view of a smart card prior to assembly;

FIG. 12 shows a cross-section view of an assembled smart card.

### DESCRIPTION OF EMBODIMENTS

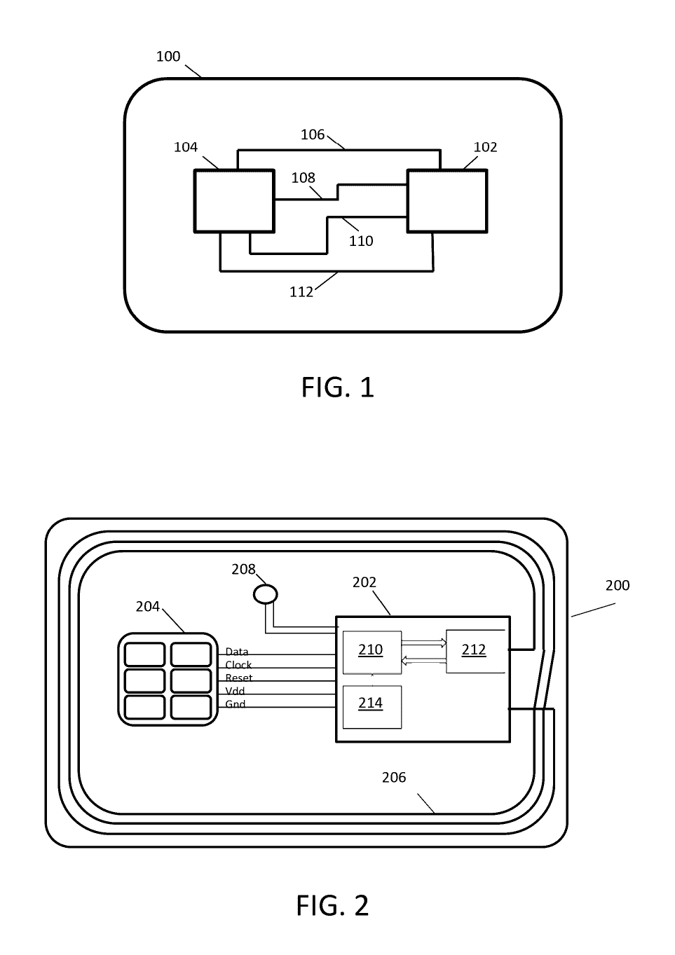

FIG. 1 shows an illustrative embodiment of an authentication token 100. The authentication token 100 may, for example, be a smart card having an ID-1 form factor as defined in the technical standard ISO/IEC 7810 (credit-card size). In accordance with the present disclosure, the authentication token 100 comprises an authentication module 102 and at least one conductive wire for operatively connecting the authentication module to at least one further module of the token, said at least one conductive wire being embedded in a non-conductive substrate of said token 100. In this example, the token 100 comprises four conductive wires 106, 108, 110, 112, and the authentication module 102 is operatively connected to an interface module 104 of said token 100 by means of said conductive wires 106, 108, 110, 112. Embedding conductive wires 106, 108, 110, 112 in a non-conductive substrate of the token 100 may result in a token 100 which is easy to produce, because module interconnects may be formed in material layers which are often present in authentication tokens of the kind set forth, without creating a separate interconnection layer. Consequently, the token 100 may be manufactured at lower cost. For example, in case the token 100 is a smart card, the non-conductive substrate may be one of the card material layers of the smart card. After embedding the conductive wires 106, 108, 110, 112 into said non-conductive substrate, the modules 102, 104 may easily be assembled on the token 100.

FIG. 2 shows an illustrative embodiment of a dual-interface smart card 200. The smart card 200 comprises a contact-bound interface and a contactless interface. The contact-bound interface enables the smart card 200 to communicate with devices in which the card 200 is physically inserted, such as automated teller machines (ATMs) and conventional payment terminals. The contactless interface enables the smart card 200 to communicate with contactless payment terminals In this example, the contact-bound interface is implemented as a contact-based interface unit 204 conforming to the technical standard ISO/IEC 7816. Furthermore, the contactless interface is implemented as a loop antenna 206. An authentication module, implemented as a fingerprint verification module 202, is operatively connected to the contact-based interface unit 204 and the loop antenna 206. In accordance with the present disclosure, the fingerprint verification module 202 may be connected to the contact-based interface unit 204 through conductive wires embedded in a non-conductive substrate of the smart card 200 (as shown in FIG. 1). For example, the conductive wires may implement Data, Clock, Reset, Vdd (voltage supply) and Gnd (ground) connections between the fingerprint verification module 202 and the contact-based interface unit 204. Optionally, the smart card 200 may contain a user feedback device 208, for example a light-emitting diode (LED). Furthermore, the fingerprint verification module 202 may comprise a processor 210 which is operatively connected to a fingerprint sensor 212. By enabling fingerprint sensing and processing functions in the authentication module, the token may be used for authorizing transactions in a relatively easy manner For example, it may be envisaged that the fingerprint sensor 212 captures a user's fingerprint, that the processor 210 performs an on-card matching function to verify whether the captured fingerprint matches a fingerprint template, and that, upon a positive verification, the fingerprint verification module 202 sends an authorization signal to an external device through the contact-based interface unit 204 or the loop antenna 206. Thus, a secure, yet easy to use, transaction authorization mechanism is implemented on the token. Optionally, the fingerprint verification module 202 may comprise a secure element 214 which is operatively connected to the processor 210. The secure element 214 may provide a secure environment for performing a fingerprint matching function. The secure element 214 may be implemented as an embedded chip, more specifically as a tamper-resistant integrated circuit with installed or pre-installed applications which have a prescribed functionality and a prescribed level of security. Furthermore, the secure element 214 may implement security functions, such as cryptographic functions.

As mentioned above, in one or more embodiments, the token comprises an interface module which is operatively connected to the authentication module through the at least one conductive wire. In the example shown in FIG. 2, the interface module is a contact-based interface unit 204 conforming to the standard ISO/IEC 7816. The use of such an interface module enables compatibility with external conventional transaction devices, such as ATMs. In particular, the authentication module may send authorization signals to such conventional transaction devices through the interface module, using a conductive wire of the kind set forth as an internal transmission line to the interface module. Furthermore, in one or more embodiments, the non-conductive substrate is a thermoplastic substrate. Thermoplastic substrates are often used as basic constituents of an authentication token; embedding the conductive wires into a thermoplastic substrate may thus enable that one of the token's basic constituents is used as a module interconnection layer. Thus, an additional interconnection layer may be dispensed with and the resulting token may become thinner and may be produced at lower cost. In more specific embodiments, the thermoplastic substrate is an inlay substrate. Embedding the conductive wires in an inlay substrate is particularly useful if the token is a smart card. Smart card inlays may be produced in large volumes before functional modules are assembled on them. By assembling modules on inlays having embedded module interconnects the modules will already become connected upon assembly and no additional manufacturing steps for establishing connectivity between the modules are required. Thus, it may become easier to produce the smart card. It is noted that the body of the smart card may be made from a stack of lamination material layers. One of these lamination material layers may be adapted for use as the module interconnection layer. Furthermore, in one or more embodiments, the authentication module is integrally formed as a single component. Thus, referring to the example shown in FIG. 2, the fingerprint sensor 212, the processor 210 and the secure element 214 may be integrally formed as a single component. More specifically, the fingerprint sensor 212, the processor 210 and the secure element 214 may be separate ICs which are integrated in a module-package. In this way, the authentication module has a minimal amount of external interfaces and may therefore be easily assembled on a smart card inlay utilizing automated placement facilities.

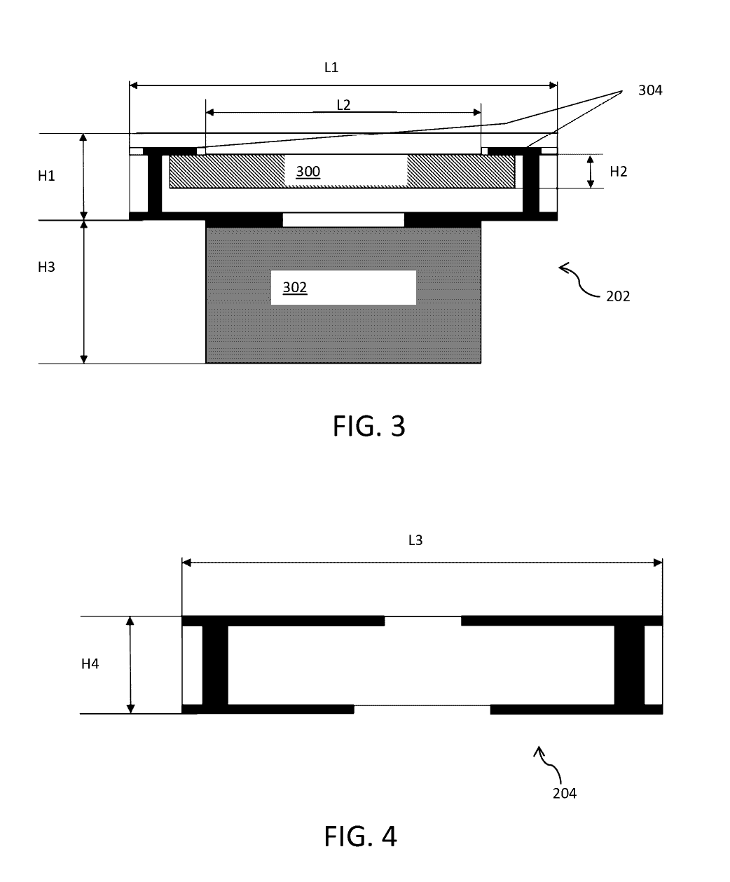

FIG. 3 shows an illustrative embodiment of an authentication module. In particular, it shows an example implementation of the fingerprint verification module 202 shown in FIG. 2. The fingerprint verification module 202 comprises a fingerprint area sensor 300 which is connected to a processing block 302 through a galvanic interconnect 304. The processing block 302 may contain the processor 210 and the secure element 214, for example. In addition, the processing block may contain a power management unit (not shown). Suitable dimensions of the fingerprint verification module 202 are: H1=200 μm, H2=100 μm, H3=400 μm, L1=14 mm, L2=10 mm. The skilled person will appreciate that other dimensions may also be possible. In this example, the fingerprint verification module 202 is configured as a T-shaped module. The fingerprint area sensor 300 may be inserted into a cavity in a substrate material, such as polyimide or FR-4, with its contact pads facing up. The sensor's contact pads may be covered by copper. The substrate may have conductive tracks placed on both sides of the substrate. A galvanic process as used for PCB manufacturing may be used to create a solid conductive connection between the sensor's contact pads and the conductive tracks on the substrate's surface. VIAs (through-hole connections) may be used to establish a conductive connection between the conductive tracks on both sides of the substrate. On the lower side the substrate may have contact pads that may be used to establish a conductive connection to the conductive wires (not shown) embedded in a non-conductive substrate of the kind set forth.

FIG. 4 shows an illustrative embodiment of an interface module. In particular, it shows an example implementation of the contact-based interface unit 204 shown in FIG. 2. In this example, contact-based interface unit 204 is configured as a brick-type module. On its top side ISO contact pad areas may be arranged (i.e. contact pads providing connectivity to an external device, e.g. an ATM). VIAs may be used to connect these contact pad areas to conductive tracks on the lower side of a substrate material. On the lower side the substrate may have contact pads that may be used to establish a conductive connection to the conductive wires (not shown) embedded in a non-conductive substrate of the kind set forth. Suitable dimensions of the contact-based interface unit 204 are: H4=200 μm, L3=14 mm. The skilled person will appreciate that other dimensions may also be possible.

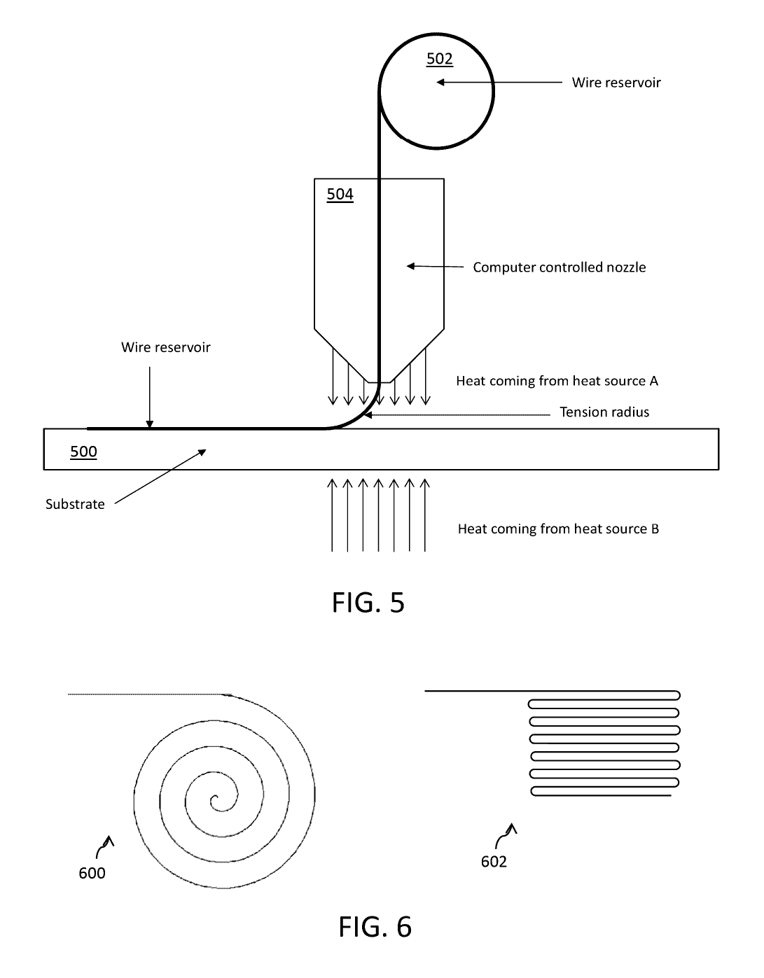

FIG. 5 shows an illustrative embodiment of a wire-embedding process. The wire-embedding process comprises embedding wire from a wire reservoir 502 into a non-conductive substrate 500 through a computer-controlled nozzle 504. In particular, the wire may be copper wire that is supplied from the wire reservoir 502 though the nozzle 504 under application of heat and force to the substrate 500. The substrate 500 may be a thermoplastic card material, such as polyvinyl chloride (PVC) or polyethylene terephthalate (PET), which may facilitate the embedding process. The position and movement of the nozzle may be controlled by a computer in the three-dimensional space. The heat may be applied, for example, by inductive heating, ultrasonic heating, focused infrared light heating or electro-resistive heating. The heat may be applied from the wire-application side but also from underneath the substrate 500 in order to reduce the amount of heat required for softening the substrate material. The wire radius (tension radius) that develops during application of the wire is used to forward the force from the nozzle 504 to the wire and to the substrate 500 in order to facilitate embedding the wire into the substrate 500. In case the wires are insulated wires, the wire insulation should be resistant against the applied heat.

FIG. 6 shows illustrative embodiments of wire endings. In particular, a wire ending 600 having a spiral pattern is shown, as well as a wire ending 602 having a meander pattern. Wire endings having a spiral pattern or a meander pattern facilitate connecting the conductive wires to the functional modules upon assembly, and may provide a good connection within a limited interface area. However, the skilled person will appreciate that other patterns may also be used for the wire endings. The endings may conveniently be prepared for connection to the functional modules by carrying out a milling process.

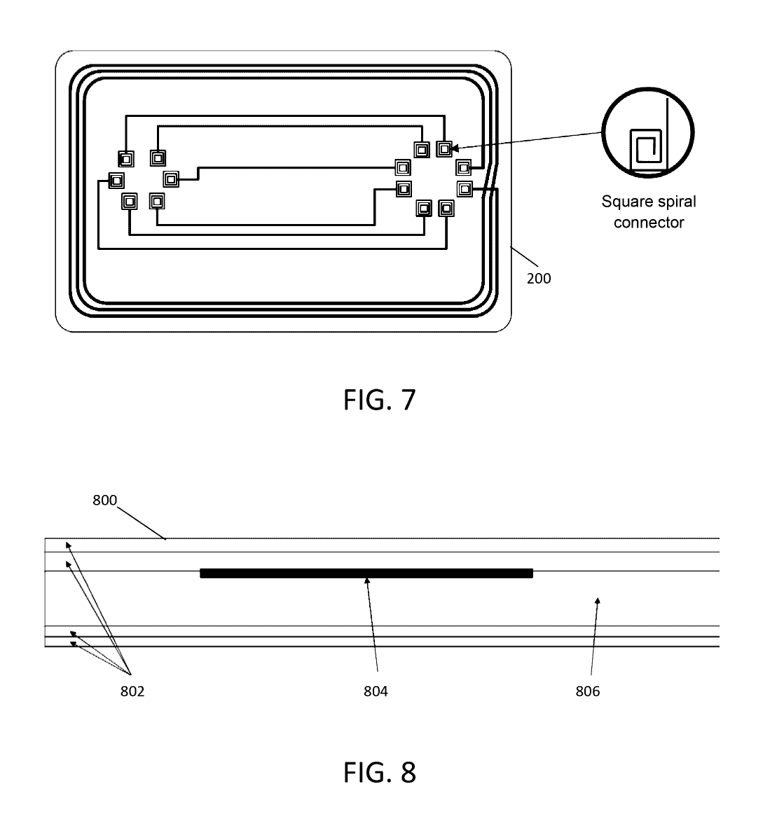

FIG. 7 shows an illustrative embodiment of a module interconnection layer of a smart card 200. The module interconnection layer comprises a non-conductive substrate in which conductive wires have been embedded. In this example, the conductive wires have endings of a square spiral form. Furthermore, the module interconnection layer contains a loop antenna which also has endings of a square spiral form. The conductive wires may thus be embedded into the same non-conductive substrate as the antenna, which may enable a low-cost implementation of the smart card 200. Furthermore, the conductive wire may be made of the same material as the antenna, which may further lower the cost. In one or more embodiments, the conductive wire is an insulated conductive wire. Using insulated conductive wires in the module interconnection layer enables track crossings without causing short-circuits, which may provide more flexibility to the design of the module interconnects.

FIG. 8 shows an illustrative embodiment of a card layer stack. As mentioned above, the body of the smart card may be made from a stack of lamination material layers 802, 806. One layer 806 of these lamination material layers may be adapted for use as the non-conductive substrate in which the conductive wire 804 is embedded. The module interconnection layer 806 which is formed thereby may be arranged with other card material layers 802 to form a card layer stack 800. The resulting card layer stack 800 is laminated in a card lamination press by applying temperature that may be above the melting temperature of the card material combined with mechanical pressure. In case of polycarbonate card material the temperature may be 200° C. and the pressure may be 5 bar (i.e., 500 kPa) applied during 20 minutes. The lamination may result in a strong linkage between the layers of the card layer stack 800 such that a solid card body may be formed.

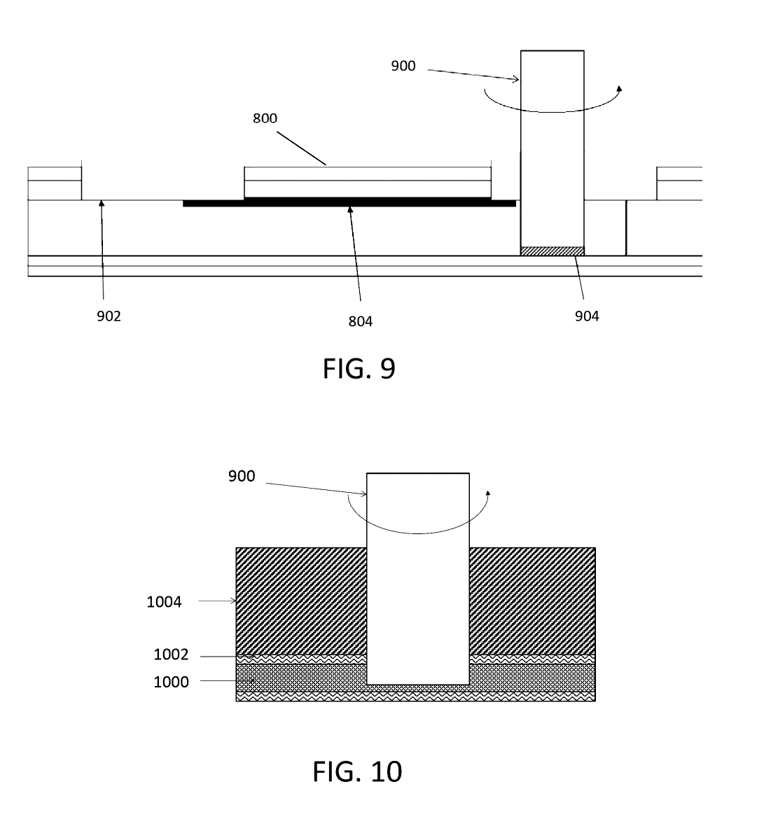

FIG. 9 shows an illustrative embodiment of a cavity creation process. After card lamination cavities may be milled into the card body, in which subsequently the interface module and the authentication module may be inserted. For the interface module, a milling tool 900 may mill a box-shaped cavity 902. For the authentication module, the milling tool 900 may mill a T-shaped cavity 904.

FIG. 10 shows an illustrative embodiment of an insulation removal process. In order to prepare endings of insulated conductive wires for connection to contact pads of the modules, the insulation of said wires should be removed. In order to achieve this, a milling process may be used. The milling process comprises milling, by a milling tool 900, an opening into a card body 1004, into an insulation layer 1002 of a wire 1000 and into a part of said wire 100. The milling process may partly remove the insulation of the wire in order to form an ending of the kind set forth.

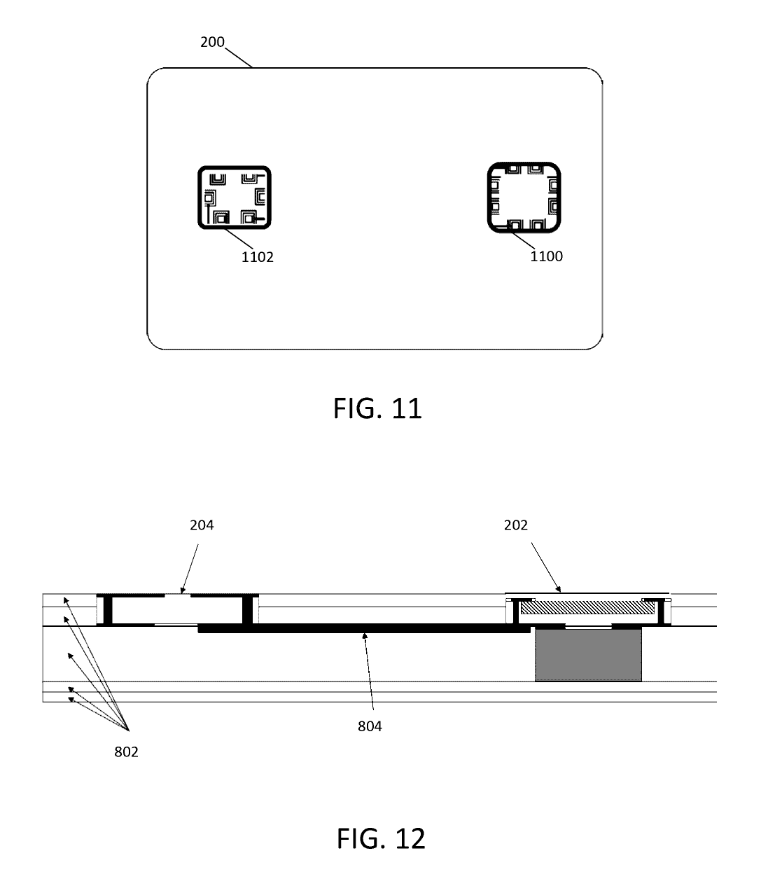

FIG. 11 shows a top view of a smart card prior to assembly. The smart card 200 comprises a first cavity 1100 for accommodating an authentication module and a second cavity 1102 for accommodating an interface module. In some embodiments, no interface module may need to be assembled and the authentication module is only connected to the two wire endings of the loop antenna This may be useful for contactless electronic documents such as electronic identification (eID) cards, because they may only require a contactless communication interface and consequently the cost of the contact-based interface unit may be saved.

FIG. 12 shows a cross-section view of an assembled smart card. The assembled smart card comprises the card material layers 802. As mentioned above, at least one conductive wire 804 may be embedded in one of these layers 802. That is to say, one of these layers 802 serves as the non-conductive substrate in accordance with the present disclosure. In a manufacturing process, the wire structure or structures may be formed first, then the card may be laminated, then an opening may be milled for inserting the functional modules 202, 204 into the card, and finally the functional modules 202, 204 may be inserted (i.e. assembled) into the card. Thus, the milling process may serve the purposes of creating a cavity for accommodating said modules 202, 204 and also for partially removing the insulation from the wire endings in order to prepare them for connection processes such as soldering and gluing. In case of soldering with, e.g., low-temperature Sn-Bi solder the required heat may be applied from the contact-pad side through the modules 202, 204. Another assembly process may apply anisotropic conductive film or glue to the modules 202, 204 before inserting them into the milled cavities. Yet another assembly process may apply isotropic glue in combination with, e.g., epoxy-based glue that provides a stable fix of the modules 202, 204 to the card body. In this case the glue is activated by applying heat to the contact-pad side, e.g., through heat available in a lamination process or by a focused infrared beam.

It is noted that the embodiments above have been described with reference to different subject-matters. In particular, some embodiments may have been described with reference to method-type claims whereas other embodiments may have been described with reference to apparatus-type claims. However, a person skilled in the art will gather from the above that, unless otherwise indicated, in addition to any combination of features belonging to one type of subject-matter also any combination of features relating to different subject-matters, in particular a combination of features of the method-type claims and features of the apparatus-type claims, is considered to be disclosed with this document. Furthermore, it is noted that the drawings are schematic. In different drawings, similar or identical elements are provided with the same reference signs. Furthermore, it is noted that in an effort to provide a concise description of the illustrative embodiments, implementation details which fall into the customary practice of the skilled person may not have been described. It should be appreciated that in the development of any such implementation, as in any engineering or design project, numerous implementation-specific decisions must be made in order to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill.

Finally, it is noted that the skilled person will be able to design many alternative embodiments without departing from the scope of the appended claims. In the claims, any reference sign placed between parentheses shall not be construed as limiting the claim. The word “comprise(s)” or “comprising” does not exclude the presence of elements or steps other than those listed in a claim. The word “a” or “an” preceding an element does not exclude the presence of a plurality of such elements. Measures recited in the claims may be implemented by means of hardware comprising several distinct elements and/or by means of a suitably programmed processor. In a device claim enumerating several means, several of these means may be embodied by one and the same item of hardware. The mere fact that certain measures are recited in mutually different dependent claims does not indicate that a combination of these measures cannot be used to advantage.

### LIST OF REFERENCE SIGNS

100 authentication token
102 authentication module
104 interface module
106 conductive wire
108 conductive wire
110 conductive wire
112 conductive wire
200 smart card
202 fingerprint verification module
204 contact-based interface unit
206 loop antenna
208 user feedback device
210 processor
212 fingerprint sensor
214 secure element
300 fingerprint area sensor
302 processing block
304 galvanic interconnect
500 non-conductive substrate
502 wire reservoir
504 computer-controlled nozzle
600 wire ending
602 wire ending
800 card layer stack
802 card material layers
804 conductive wire
806 non-conductive substrate
900 milling tool
902 box-shaped cavity
904 T-shaped cavity
1000 conductive wire
1002 insulation
1004 card body
1100 cavity
1102 cavity

1. An authentication token comprising an authentication module and at least one conductive wire for operatively connecting the authentication module to at least one further module of the token, said at least one conductive wire being embedded in a non-conductive substrate of said token.

2. A token as claimed in claim 1, wherein the authentication module comprises a fingerprint sensor and a processing unit which are operatively connected to each other.

3. A token as claimed in claim 2, wherein the authentication module further comprises a secure element which is operatively connected to the processing unit.

4. A token as claimed in claim 1, further comprising an interface module, wherein the authentication module is operatively connected to the interface module through the at least one conductive wire.

5. A token as claimed in claim 4, wherein the interface module is a contact-based interface unit, in particular an interface unit conforming to the technical standard ISO/IEC 7816.

6. A token as claimed in claim 1, wherein the non-conductive substrate is a thermoplastic substrate.

7. A token as claimed in claim 6, wherein the thermoplastic substrate is an inlay substrate.

8. A token as claimed in claim 1, wherein the authentication module is integrally formed as a single component.

9. A token as claimed in claim 1, wherein the conductive wire has at least one ending that has a meander form or a spiral form and that serves as a contact pad for connecting the authentication module or the further module to said conductive wire.

10. A token as claimed in claim 9, wherein said ending has been prepared for connection to the authentication module or the further module by carrying out a milling process.

11. A token as claimed in claim 1, further comprising an antenna embedded in the non-conductive substrate.

12. A token as claimed in claim 11, wherein the conductive wire is made of the same material as said antenna.

13. A token as claimed in claim 1, wherein the conductive wire is an insulated conductive wire.

14. A token as claimed in claim 1, being a smart card.

15. A method of manufacturing an authentication token, the method comprising providing the token with an authentication module and with at least one conductive wire for operatively connecting the authentication module to at least one further module of the token, wherein said at least one conductive wire is embedded in a non-conductive substrate of said token.
